(19) United States
(12) Patent Application Publication
(10) Pub. No.: US 2026/0170103 A1
(43) Pub. Date: Jun. 18, 2026

(54) INVALIDATE WEB SESSIONS PRESENT IN SUPPORT UPLOADED HAR FILE

(71) Applicant: International Business Machines Corporation, Armonk, NY (US)

(72) Inventors: David MOORE, Carrara (AU); Scott Matthew ANDREWS, Ashmore (AU)

(21) Appl. No.: 18/978,121

(22) Filed: Dec. 12, 2024

(51) Int. Cl. G06F 21/31

(52) U.S. Cl. CPC G06F 21/31

(57) ABSTRACT

Method and apparatus for improve support system service application security. HAR files sent to support system service applications can contain personal or private information. Such personal or private information may be contained in authenticated tokens within the HAR file. The authenticated tokens may still be authenticated when the HAR file reaches the support system service application. Embodiments herein relate to scanning the HAR file, detecting the authenticated tokens within the HAR file, and instructing an action to occur to invalidate the tokens.

### BACKGROUND

The present invention relates to HTTP archive (HAR) files, and more specifically, to web session security. When debugging web applications, HAR files capture a comprehensive log of HTTP requests and responses made during browsing sessions. Details such as resource loading times, HTTP statues codes, cookies, headers or other associated data can be included in the HAR file. A HAR file can be sent to a support system service application, allowing support engineers to analyze network activity directly, pinpointing issues such as slow load times, filed resources requests, unexpected redirects, etc.

### SUMMARY

According to one embodiment a method includes receiving, a http archive (HAR) file generated at a user device; scanning the HAR file to detect an authenticated token; and generating, upon detecting the authenticated token, instructions to invalidate the detected authenticated token to prevent subsequent use of a session corresponding to the authenticated token and the user device.

### BRIEF DESCRIPTION OF THE DRAWINGS

FIG. 1 illustrates a functional block diagram illustrating a networked environment, in accordance with an example embodiment of the present invention.

FIG. 2 illustrates a HAR file scanner, according to some embodiments.

FIG. 3A illustrates support system storage architecture, according to some embodiments.

FIG. 3B illustrates support system storage architecture, according to some embodiments.

FIG. 4 illustrates a flow diagram of instructing invalidating authenticated tokens, according to some embodiments.

FIG. 5 illustrates a flow of instructing invalidating authenticated tokens, according to some embodiments.

### DETAILED DESCRIPTION

According to one embodiment a method includes receiving, a http archive (HAR) file generated at a user device; scanning the HAR file to detect an authenticated token; and generating, upon detecting the authenticated token, instructions to invalidate the detected authenticated token to prevent subsequent use of a session corresponding to the authenticated token and the user device. By performing the method, the response may improve the security of sensitive information.

Also in some embodiments, the session of the method is part of a support system service application. As a result, the session is more conveniently accessed.

Also in some embodiments, the session of the method corresponding to the authenticated tokens and the user device enables access to a support system service application. As a result, performing the method improves access to the support system service application.

Also in some embodiments, the instructions to invalidate the detected authenticated token of the method includes instructions to ensure access to the support system service application is no longer enabled. As a result, the efficiency of securing sensitive information is improved.

Also in some embodiments, the method includes moving the HAR file to a storage architecture within the support system service application. As a result, efficiency for storing and securing sensitive information improved.

Also in some embodiments, the authenticated token is selected from a group consisting of a cookie or security token that enable the session. As a result, identifying sensitive information is done so more easily.

Also in some embodiments, the method includes invalidating the detected authenticated tokens of the HAR file based on the generated instructions. As a result, sensitive information is secured more efficiently.

In another embodiment, a computer program product for support system service application security, the computer program product includes: a computer-readable storage medium having computer-readable program code embodied therewith, the computer-readable program code executable by one or more computer processors to: receive, a http archive (HAR) file generated at a user device; scan the HAR file to detect an authenticated token; and generate, upon detecting the authenticated token, instructions to invalidate the detected authenticated token to prevent subsequent use of a session corresponding to the authenticated token and the user device. As a result, the response may improve the security of sensitive information.

Also in some embodiments, the session is part of a support system service application. As a result, the session is more conveniently accessed.

Also in some embodiments, the session corresponding to the authenticated tokens and the user device enables access to a support system service application. As a result, access to the support system service application is improved.

Also in some embodiments, the instructions to invalidate the detected authenticated token includes instructions to ensure access to the support system service application is no longer enabled. As a result, the efficiency of securing sensitive information is improved.

Also in some embodiments, the computer program product includes moving the HAR file to a storage architecture within the support system service application. As a result, efficiency for storing and securing sensitive information improved.

Also in some embodiments, the authenticated token is selected from a group consisting of a cookie or security token that enable the session. As a result, identifying sensitive information is done so more easily.

Also in some embodiments, the computer program product includes invalidating the detected authenticated tokens of the HAR file based on the generated instructions. As a result, sensitive information is secured more efficiently.

In another embodiment, a computer system for identifying privileged access to a database, the computer system includes: one or more computer processors; one or more computer readable storage media; and program instructions stored on the computer readable storage media for execution by at least one of the one or more processors, the program instructions including: program instructions to receive, a http archive (HAR) file generated at a user device; program instructions to scan the HAR file to detect an authenticated token; and program instructions to generate, upon detecting the authenticated token, instructions to invalidate the detected authenticated token to prevent subsequent use of a session corresponding to the authenticated token and the user device. As a result, the response may improve the security of sensitive information.

Also in some embodiments the session is part of a support system service application. As a result, the session is more conveniently accessed.

Also in some embodiments, the session corresponding to the authenticated tokens and the user device enables access to a support system service application. As a result, access to the support system service application is improved.

Also in some embodiments, the instructions to invalidate the detected authenticated token includes instructions to ensure access to the support system service application is no longer enabled. As a result, the efficiency of securing sensitive information is improved.

Also in some embodiments, the computer system includes moving the HAR file to a storage architecture within the support system service application. As a result, efficiency for storing and securing sensitive information improved.

Also in some embodiments, the authenticated token is selected from a group consisting of a cookie or security token that enable the session. As a result, identifying sensitive information is done so more easily.

Embodiments herein relate to HAR file security. HAR files sent to support system service applications can contain personal or private information. Such personal or private information may be contained in authenticated tokens within the HAR file. The authenticated tokens may still be authenticated when the HAR file reaches the support system service application. Embodiments herein relate to scanning the HAR file, detecting the authenticated tokens within the HAR file, and instructing an action to occur to invalidate the tokens. Embodiments herein provide security improvements, as they prevent nefarious actors from gaining access to the support system service application from viewing the sensitive information contained in the HAR file.

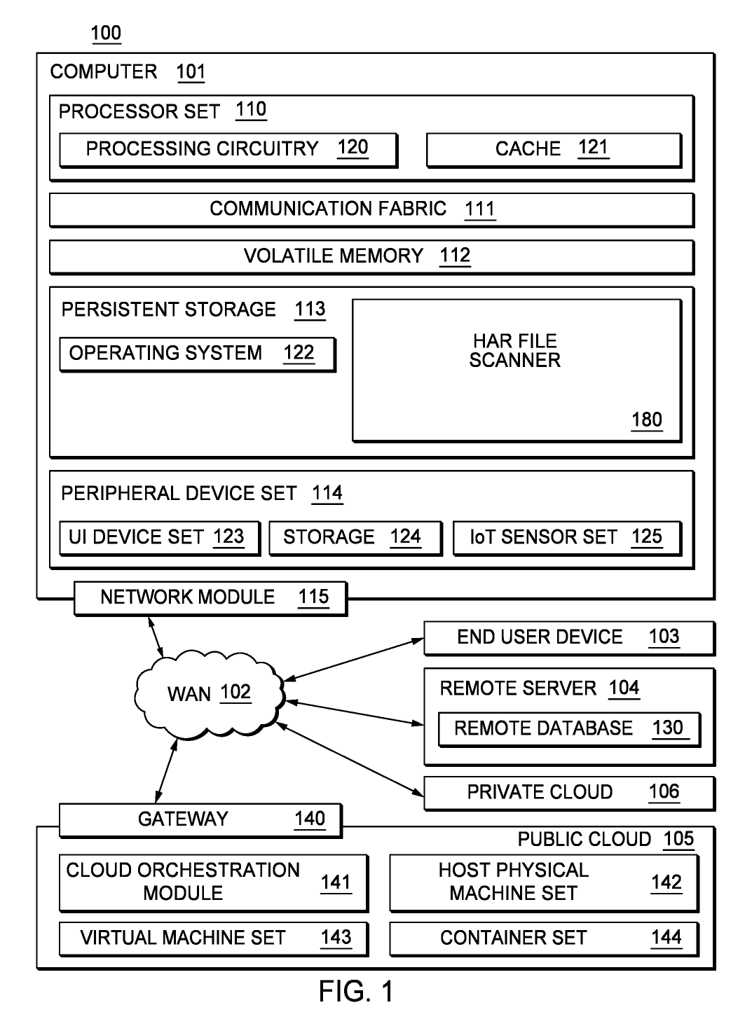

With reference now to FIG. 1

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as Block 180 illustrates a HAR file scanner, improving the security of the support system service application. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

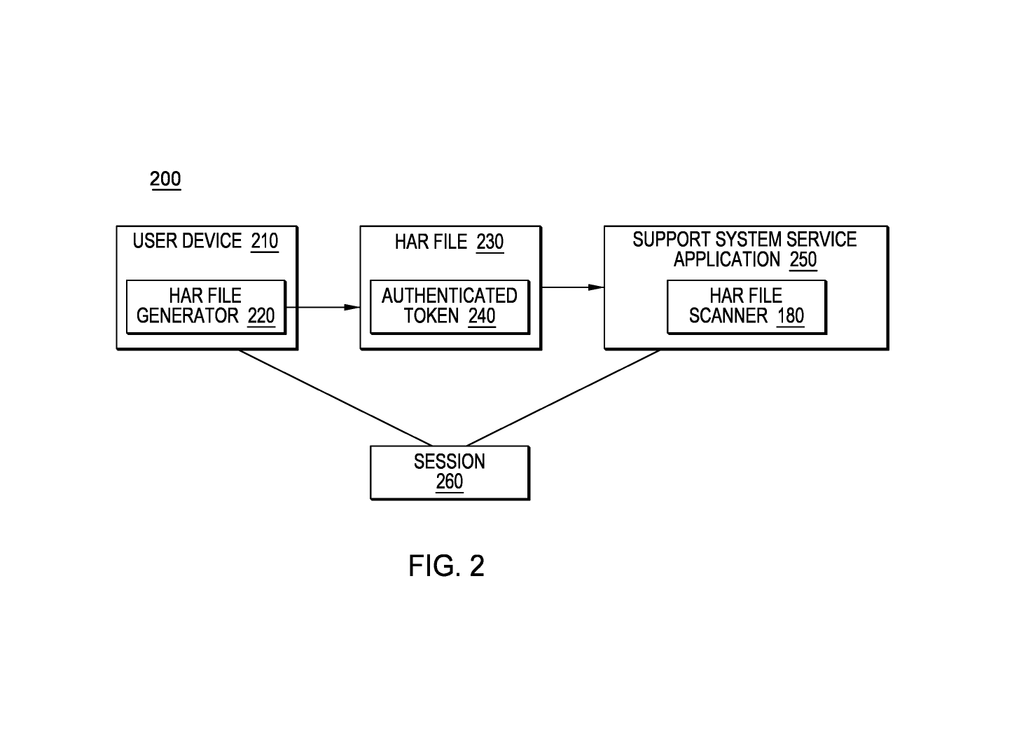

FIG. 2 illustrates a user device 210 generating a HAR file 230 using a HAR file generator 220. The user device 210 creates a session between itself and support system service application 250. While the session is active, the user device 210 can generate a HAR file 230 and send the HAR file 230 to the support system service application 250. The session 260 allows the user to communicate issues, receive assistance, and share relevant data (such as the HAR file 230) with the support system service application 250. While the session 260 is active, the support system service application 250 can track user activity, gather contextual information, and attempt to resolve technical issues from the user device. The session 260 can involve live chats, email-style ticketing, or guided diagnostics, among other things. Once the session 260 has been completed, the HAR file scanner 180 can scan the uploaded HAR file 230 and check to see whether the HAR file 230 contains one or more authenticated tokens such as the authenticated token 240. As an improvement to security, if the HAR file scanner 180 detects the authenticated token 240, it can initiate a deactivation or invalidation process so that sensitive information can no longer be accessed once the session 260 between the user device 210 and the support system service application 250 is expired.

The user device 210 can be a variety of devices, including smartphones, tablets, laptops, desktops, and smart home devices. Smartphones and tablets may be more commonly used due to their portability, enabling users to access support system service applications 250 on the on the go. However laptops and desktops may also be used, as they can offer a more robust experience with larger screens and full keyboard access, which can be advantageous when navigating complex support portals or uploading the HAR file 230 to the support system service application 250.

Once the session 260 between the user device 210 and the support system service application 250 is secured, the user device 210 generates a HAR file 230 using a HAR file generator 220. The HAR file generator 220 is a software tool within the web browser or software environment of the user device 210 that records and saves HTTP activity between a client (or browser) and a server. The HAR file generator 220 produces the HAR file 230. The HAR file 230 details requests and responses made while loading a page or using an application, capturing valuable data such as request timings, status codes, headers, cookies, other transferred data, or cookie or security tokens that enable the session, including authenticated tokens 240.

To generate a HAR file 230, the HAR file generator 220 monitors and records the network requests sent and received from the browser of the user device 210. The generated HAR file 230 provides a breakdown of network activity in a structured, readable format, making it easier for the support system service application 250 to identify performance bottlenecks, excessive loading times, or other potential issues. The HAR file 230 can contain authenticated tokens such as the authenticated token 240. Authenticated tokens in HAR files can include pieces of data that confirm a user’s identity and grant access to restricted areas or functions within a web application. These authenticated tokens, or session cookies, can be included in the headers of HTTP requests to let the server know that the user has already been authenticated. The server refers to the web application’s backend system that can handle requests and delivers data to entities such as the support system service application. The authenticated token 240 may carry information that can grant access to user accounts or data that are considered sensitive. If these tokens are recorded on the HAR file 230 as shown in FIG. 2, any entity with access to the HAR file 230, including an entity that can access the support system service application 250, where the HAR file 230 has been uploaded, can access to the authenticated token 240 of the HAR file 230.

The support system service application 250 refers to software that enables organizations to manage customer support and handle service requests efficiently. The support system service application 250 can provide tools for tracking, prioritizing, and resolving customer inquiring across various channels, such as email, chat, phone and social media. The support system service application 250 can include features such as ticket management, live chat, knowledge bases, and customer relationship management integration features to help streamline communication between customers and support agents, among other features to help handle large volumes of inquiries in a timely, organized manner.

To generate the session 260 between the user device 210 and the support system service application 250, contact between the two entities may be initiated by the user device accessing the support system service application 250 through a browser, mobile app, desktop application, etc. The interaction between the user device 210 and the support system service application 250 begins the session 260, or a temporary connection where the user device 210 and the support system service application 250 exchange data. When the user device 210 establishes connection to the support system service application 250, the user device 210 may generate a HAR file 230 through the HAR file generator 220. At this point, the user device 210 is connected to the support system service application 250, and the HAR file 230 may contain authenticated tokens 240 which identify the session 260 and can grant access to sensitive data. The HAR file 230 can be uploaded to the support system service application 250, giving entities with access to the support system service application 250 access to the authenticated token 240 within the HAR file 230.

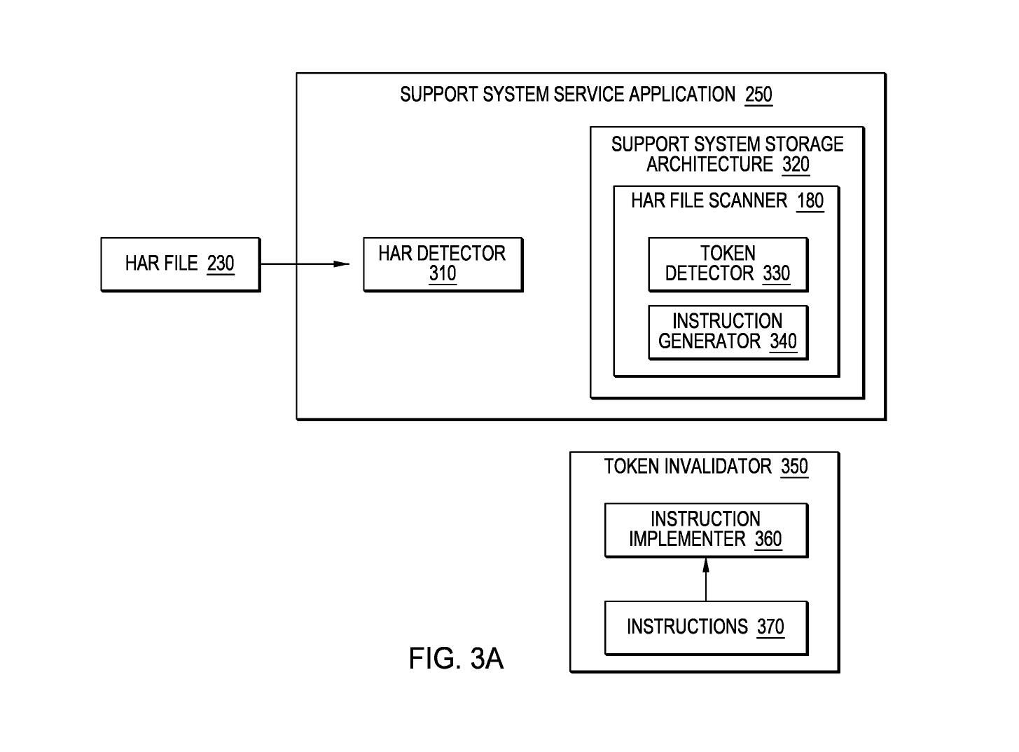

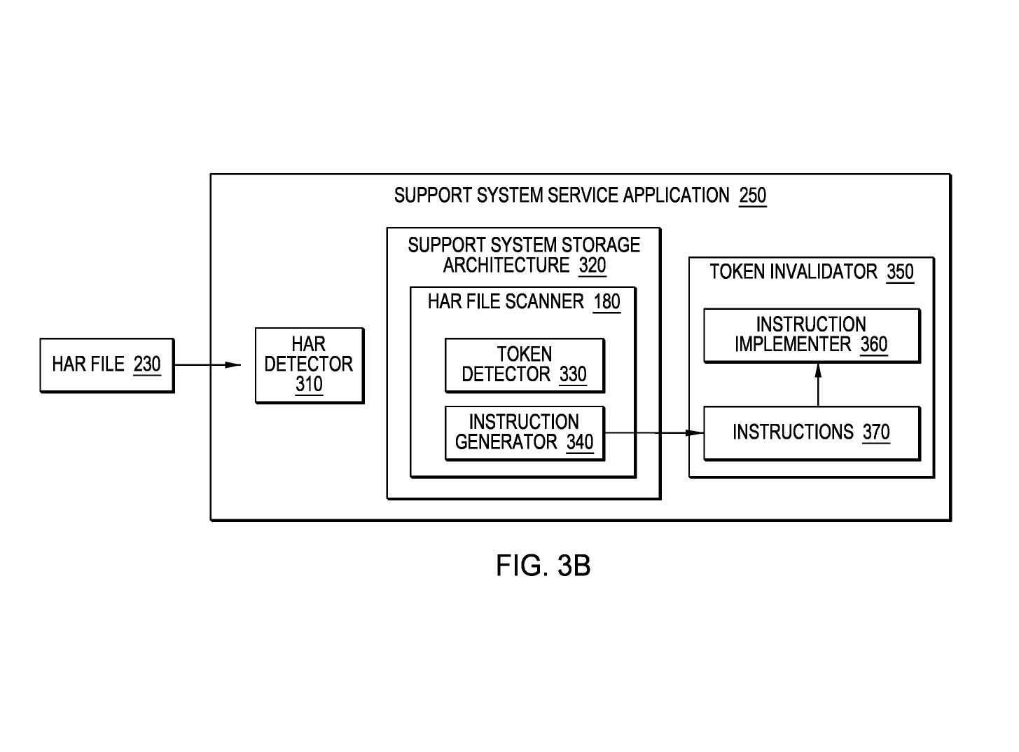

To improve security measures, the support system service application 250 includes a HAR file scanner 180. The HAR file scanner 180 scans the uploaded HAR file 230 to detect whether authenticated tokens, such as the authenticated token 240, are still present in the HAR file 230, even after the session 260 expires. The HAR file scanner 180 is discussed in more detail in FIGS. 3A and 3B.

FIGS. 3A and 3B illustrate the architecture of the support system storage application 250, including the HAR file scanner 180. The HAR file 230 is uploaded to the support system service application 250. The support system service application 250 contains a HAR detector 310 which detects the HAR file 230. The HAR detector 310 can monitor file attachments that users submit. When the HAR file 230 is uploaded, the HAR detector 310 may detect the HAR file 230 by checking the HAR file’s 230 format and metadata to determine its type. The HAR detector 310 can also scan the file contents to confirm it matches HAR criteria, verifying that the uploaded data includes HTTP log elements like request and log details.

Once the HAR detector 310 detects the uploaded HAR file 230, the support system service application 250 may trigger the HAR file 230 to be moved to the support system storage architecture 320 of the support system service application. The support system storage architecture 320 can be designed to hold a variety of user uploaded files securely, ensuring that sensitive data, such as the HAR file 230 is accessible within the support system service application 250. Embodiments herein feature an improvement to the security of the support system storage architecture 320 of the support system service application 250, as the support system storage architecture 320 includes a HAR file scanner 180.

The HAR file scanner 180 analyzes the HAR file 230 for authenticated tokens, such as the authenticated token 240. The HAR file scanner 180 can locate the HTTP requests and responses logged during the session 260, and can detect tokens used for session authentication, such as the authenticated token 240, which can contain identifying strings that provide ongoing access to the session data. The token detector 330 can distinguish the authenticated token 240 from other types of data in the scanned HAR file 230 using techniques such as pattern matching and heuristic algorithms, among other things. For example, session cookies or the authenticated token 240 may have known names or prefixes that align with keywords recognizable by the token detector 330.

Once the token detector 330 identifies the authenticated token 240 of the HAR file 230, the instruction generator 340 of the HAR file scanner 180 may be triggered. The instruction generator 340 generates instructions for the token invalidator 350 to invalidate the detected authenticated token 240.

In FIG. 3A the token invalidator is external to the support system service application 250. Instances where the token invalidator is external to the support system service application may arise when token management and security is centralized across multiple applications. This can help invalidate tokens uniformly when a user logs out or when a session expires.

In FIG. 3B the token invalidator is contained within the support system service application 250.

The token invalidator 350 contains an instruction implementer 360, which reads the generated instructions 370 from the instruction generator 340 and implements them. For example, instructions 370 can indicate that the HAR file scanner 180 detected the authenticated token 240 and include a command to invalidate the authenticated token 240. The instruction implementer 360 takes action to invalidate the authenticated token 240, i.e. deleting the authenticated token 240.

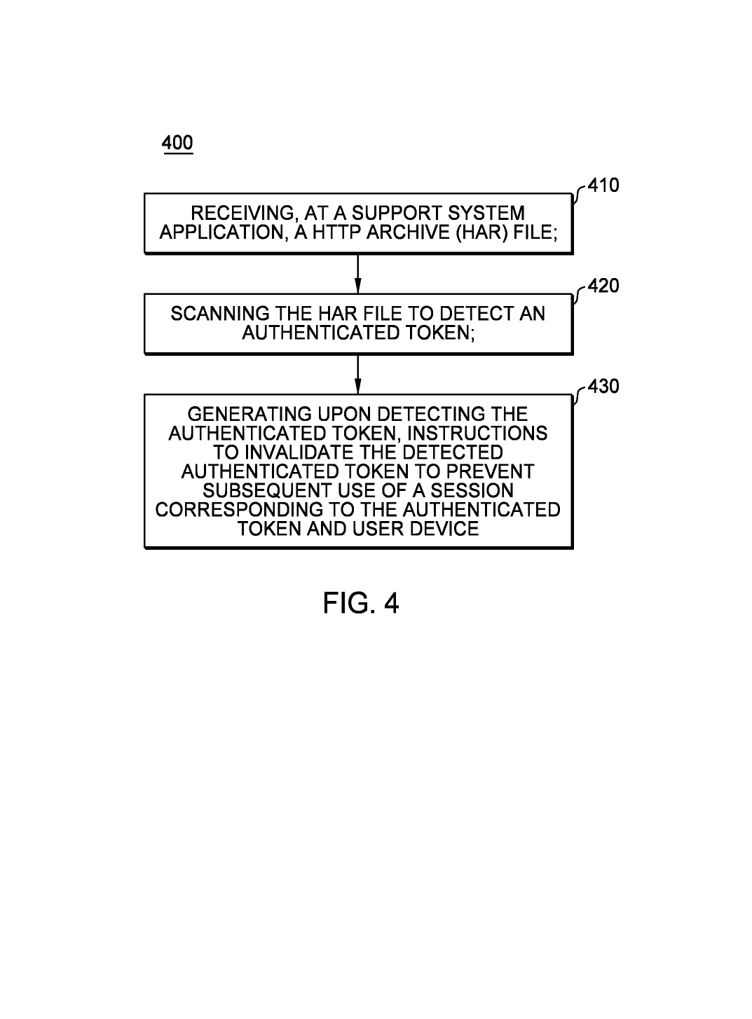

FIG. 4 illustrates a flowchart 400 for generating instructions to invalidate the detected authenticated token 240.

At block 410 the support system service application 250 receives the uploaded HAR file 230 from the user device 210. As discussed in FIG. 2, once a session is established between a user device and support system service application, the user device generates a HAR file containing data that the support system service application may find useful. The HAR file can be uploaded to the support system service application in a variety of ways, including via email, a mobile app connection, etc.

At block 420 the HAR file scanner 180 of the support system service application 250 scans the HAR file 230 to determine whether or not it contains authenticated tokens. As discussed in FIG. 3A and FIG. 3B, the file scanner 180 can use various techniques such as pattern recognition or text recognition to detect whether the authenticated token 240 exists in the HAR file 230.

At block 430 the instruction generator 340 generates instructions to invalidate the detected authenticated token(s) to prevent subsequent use of a session corresponding to the authenticated token and user device. Also as discussed in FIG. 3A and FIG. 3B, when the HAR file contains authenticated tokens, instructions can be sent to an external entity, or a feature within the support system service application to invalidate the authenticated tokens. Instructions can include deleting session data, deleting the authenticated token, among other things.

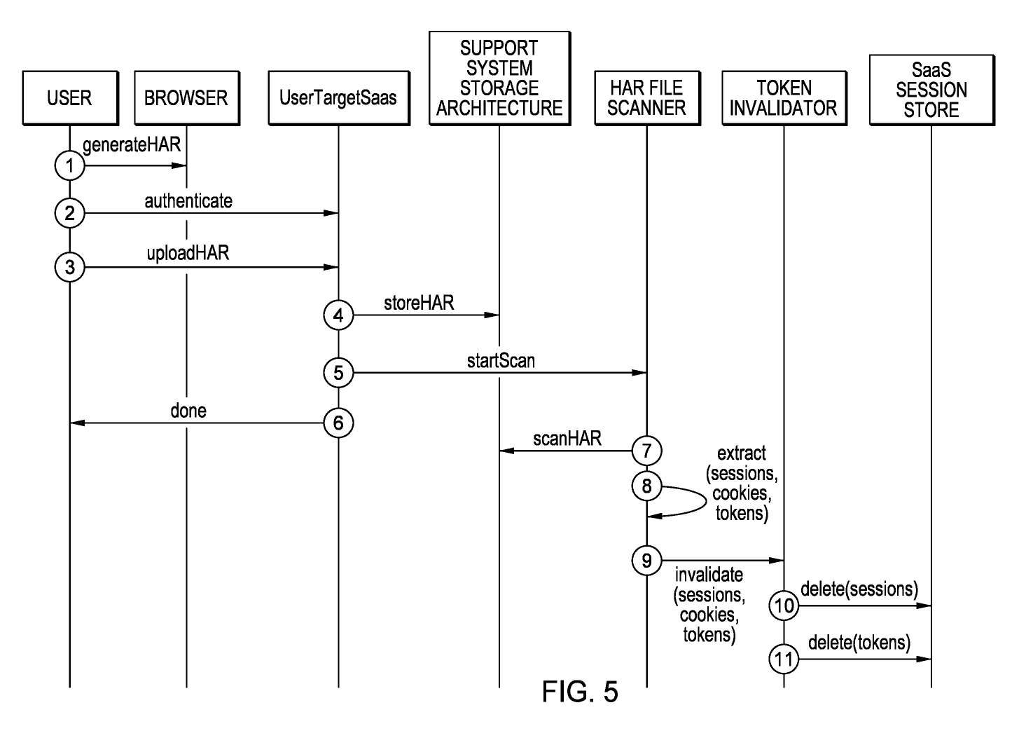

FIG. 5 illustrates an example of a flow for invalidating the authenticated token 240. FIG. 5 illustrates a user generating a HAR file 230. The current embodiment shows the upload happening via a browser, but in other embodiments, the HAR file may be uploaded to the support system service application in an email attachment, among other things. When the HAR file is uploaded to the support system service application, the HAR file may be moved to a support system storage architecture within the support system service application. The HAR file scanner proceeds to scan the uploaded HAR file to determine whether it contains authenticated tokens. The scan can be initiated once the HAR file is uploaded, or once the HAR file moved to the support system storage architecture. Once the HAR file is scanned, if authenticated tokens are detected, the token invalidator is triggered. As mentioned in FIGS. 3A and FIG. 3B, the token invalidator may be part of the support system service application, or it may be an external entity. The token invalidator invalidates the detected authenticated tokens.

In the embodiment presented in FIG. 5, a user target SaaS architecture is included. As shown, a user can generate a HAR file from their browser by using developer tools. This can be done by navigating a network tab, recording network activity, interacting with the user target SaaS platform, and then saving the captured data. Examples of target SaaS platforms include but are not limited to, customer relationship management tools, collaboration software, e-commerce platforms, and customer support solutions. After generating the HAR file, the user can authenticate the target SaaS platform and upload the HAR file.

Once the HAR file is uploaded and reaches the support system storage architecture, it can be managed independently of the target SaaS. This separation ensures that even if a bad actor gains access to the storage where the HAR file is kept, the target SaaS remains secure. Since the target SaaS has its own authentication mechanisms, the bad actor cannot directly use the tokens or session data from the HAR file without breaching the SaaS platform itself.

While the foregoing is directed to embodiments of the present invention, other and further embodiments of the invention may be devised without departing from the basic scope thereof, and the scope thereof is determined by the claims that follow.

What is claimed is:

1. A method comprising:
receiving, a http archive (HAR) file generated at a user device;
scanning the HAR file to detect an authenticated token; and
generating, upon detecting the authenticated token, instructions to invalidate the detected authenticated token to prevent subsequent use of a session corresponding to the authenticated token and the user device.

2. The method of claim 1, wherein the session is part of a support system service application.

3. The method of claim 1, wherein the session corresponding to the authenticated tokens and the user device enables access to a support system service application.

4. The method of claim 2, wherein the instructions to invalidate the detected authenticated token comprises instructions to ensure access to the support system service application is no longer enabled.

5. The method of claim 2 further comprising:
moving the HAR file to a storage architecture within the support system service application.

6. The method of claim 1, wherein the authenticated token is selected from a group consisting of a cookie or security token that enable the session.

7. The method of claim 1, further comprising:
invalidating the detected authenticated tokens of the HAR file based on the generated instructions.

8. A computer program product for support system service application security, the computer program product comprising:
a computer-readable storage medium having computer-readable program code embodied therewith, the computer-readable program code executable by one or more computer processors to:
receive, a http archive (HAR) file generated at a user device;
scan the HAR file to detect an authenticated token; and
generate, upon detecting the authenticated token, instructions to invalidate the detected authenticated token to prevent subsequent use of a session corresponding to the authenticated token and the user device.

9. The computer program product of claim 8, wherein the session is part of a support system service application.

10. The computer program product of claim 8, wherein the session corresponding to the authenticated tokens and the user device enables access to a support system service application.

11. The computer program product of claim 9, wherein the instructions to invalidate the detected authenticated token comprises instructions to ensure access to the support system service application is no longer enabled.

12. The computer program product of claim 9 further comprising:
moving the HAR file to a storage architecture within the support system service application.

13. The computer program product of claim 8, wherein the authenticated token is selected from a group consisting of a cookie or security token that enable the session.

14. The computer program product of claim 8, further comprising:
invalidating the detected authenticated tokens of the HAR file based on the generated instructions.

15. A computer system for identifying privileged access to a database, the computer system comprising:
one or more computer processors;
one or more computer readable storage media; and
program instructions stored on the computer readable storage media for execution by at least one of the one or more processors, the program instructions comprising:
program instructions to receive, a http archive (HAR) file generated at a user device;
program instructions to scan the HAR file to detect an authenticated token; and
program instructions to generate, upon detecting the authenticated token, instructions to invalidate the detected authenticated token to prevent subsequent use of a session corresponding to the authenticated token and the user device.

16. The computer system of claim 15, wherein the session is part of a support system service application.

17. The computer system of claim 15, wherein the session corresponding to the authenticated tokens and the user device enables access to a support system service application.

18. The computer system of claim 16, wherein the instructions to invalidate the detected authenticated token comprises instructions to ensure access to the support system service application is no longer enabled.

19. The computer system of claim 16 further comprising:
moving the HAR file to a storage architecture within the support system service application.

20. The computer system of claim 15, wherein the authenticated token is selected from a group consisting of a cookie or security token that enable the session.
